(19) United States
(12) Patent Application Publication
(10) Pub. No.: US 2025/0129946 A1
(43) Pub. Date: Apr. 24, 2025

(54) HOME APPLIANCE

(71) Applicant: LG Electronics Inc., Seoul (KR)

(72) Inventor: Minje YEO, Seoul (KR)

(21) Appl. No.: 18/925,864

(22) Filed: Oct. 24, 2024

(30) Foreign Application Priority Data
Oct. 24, 2023 (KR) 10-2023-0142876

(51) Int. Cl. F24C 15/02

(52) U.S. Cl. CPC F24C 15/02

(57) ABSTRACT

An appliance includes a casing having a storage space, a door, a first electronic component disposed outside the casing, a second electronic component disposed at the door, a wire, and a wire guide. The door is disposed at a front of the storage space and configured to open and close at least a portion of the storage space. The wire is configured to electrically connect the first electronic component and the second electronic component. The wire guide is disposed at the casing and has a guide channel that is configured to store the wire.

### CROSS REFERENCE TO RELATED APPLICATION

The present application claims priority to and the benefit of Korean Patent Application No. 10-2023-0142876, filed on Oct. 24, 2023, the disclosure of which is incorporated herein by reference in its entirety.

### TECHNICAL FIELD

The present disclosure relates to a home appliance.

### BACKGROUND

Home appliances, such as cooking appliances, refrigerators, and garment care devices, may have doors that provide access to storage spaces for storing items. These appliances may include a casing exterior with an interior compartment for storing objects, along with a door for opening and closing the compartment.

In some cases, electronic components may be installed on a door of a home appliance. For example, a touch sensor device, a display device, a lighting device, communication device, etc. may be installed on the door. These electronic components may operate by receiving power supplied from a main body of the home appliance.

The electronic components may be electrically connected, via a wire, to a main control portion located in the body of the home appliance. The wire may be arranged inside the main body of the home appliance to connect the electronic components of the door to the main control portion. Both ends of the wire disposed inside the main body may be connected to the electronic components of the door and the main control part, respectively.

However, the wire provided in an electric home appliance with a high internal temperature, such as a cooking appliance equipped with a heating device, may be exposed to temperatures that are greater than an allowable threshold temperature. In particular, the wire disposed inside the main body of the home appliance may be in close proximity to the heating device, which may increase the risk of the wire overheating and being damaged more easily. In such cases, wires used to connect communication devices or imaging devices may be more vulnerable to high-temperature environments, because applying high heat-resistant coatings can be difficult due to the nature of the product.

In addition, if the wire is disposed inside the main body of the home appliance, there may be issues with poor workability regarding separating/assembling of the wire. For example, for maintenance purposes, when the wire may be separated or assembled, a worker may access an interior of the narrow body, which may reduce workability.

In some examples, the wire may be disposed along the outer edge of the casing. For example, the wire may be provided along the casing surface of the home appliance. In such cases, the temperature of the wire may be relatively lower compared to when the wire is disposed inside the main body of the home appliance, but since the casing of the home appliance is also made of metal, heat from the heating device may be transmitted to the wire.

Additionally, the wire may be arranged around the outer edge of the casing so as not to be adjacent to the casing of the home appliance main body. For example, the wire may extend from a lower portion of the door along the bottom of the home appliance to the rear of the home appliance. The wire extending to the rear of the home appliance may extend upward along the rear of the home appliance and may be connected to the main control part.

However, if the wire is arranged around the outer edge of the home appliance like this, not only may the length of the wire increase, leading to increased manufacturing costs, but there may also be an issue of increased noise in the signal. In particular, regarding electronic components, communication devices and imaging devices may be sensitive to noise interference, which may lead to performance degradation as the length of the wire increases.

In some cases, built-in home appliances that are stored inside furniture may be used. However, in the process of storing a built-in home appliance inside furniture, there may be a risk that wires exposed to the outside of the home appliance may get caught on a surface of the furniture, which may result in damage or disconnection.

### SUMMARY

The present disclosure describes a home appliance that shortens the wire installation path between a main body and a door while also insulating the wire from heat or cold air of the home appliance transmitted to the wire.

The present disclosure further describes preventing wires from being damaged during an installation of the home appliance onto furniture.

The present disclosure further describes arranging the wire along a certain installation path inside the home appliance.

The present disclosure further describes minimizing wire exposure by arranging the wire slightly toward the rear, away from the front of the home appliance.

According to one aspect of the subject matter described in this application, an appliance can include: a casing having a storage space therein; a door disposed at a front of the storage space and configured to open and close at least a portion of the storage space; a first electronic component disposed outside the casing; a second electronic component disposed at the door; a wire configured to electrically connect the first electronic component and the second electronic component; and a wire guide disposed at the casing and having a guide channel that is configured to store the wire.

Implementations according to this aspect can include one or more of the following features. For example, the wire guide can be disposed at a side surface of the casing in a height direction of the casing.

In some implementations, the wire guide can be disposed closer to the door than a center of a side surface of the casing.

In some implementations, the appliance can further include an equipment room that is defined at an upper portion of the casing and configured to receive the first electronic component. The wire guide can be disposed between a first point at an entrance of an interior of the equipment room and a second point at an entrance to the door.

In some implementations, a first end of the guide channel can be opened toward the equipment room and a second end of the guide channel can be opened toward a lower portion of the door. In some examples, the upper portion of the casing can define the equipment room and a through-hole. The wire guide can define a guide hole at one end of the wire guide, the guide hole being connected to the through-hole. The wire guide can include a guide arm that is configured to be inserted into the through-hole. The guide arm can protrude from the one end of the wire guide and can protrude from an edge of the guide hole.

In some implementations, the wire guide can include a guide base disposed at a side surface of the casing, and a guide cover that is coupled to the guide base. The guide base and the guide cover can define the guide channel.

In some implementations, the guide base can include a bottom part configured to accommodate the wire, and a pair of fence parts disposed at a first side and a second side of the bottom part. The guide channel can be defined between the bottom part and the pair of fence parts. The wire guide can include a partition rib that protrudes from the bottom part. The partition rib can be disposed between the pair of fence parts to thereby partition the guide channel.

In some implementations, the wire guide can include a first guide part extending toward the equipment room, and a second guide part that is disposed at one side of the first guide part and extends toward the door.

In some implementations, the first guide part and the second guide part can extend in different directions from each other.

In some implementations, the first guide part can define a guide hole that is opened toward the equipment room, and the second guide part can define a door connection hole that is opened toward a lower portion of the door.

In some implementations, the wire guide can include a first wire guide, and a second wire guide that is positioned at a different height from the first wire guide. The first wire guide and the second wire guide can define a continuous guide path.

In some implementations, the first wire guide can define a first channel hole at a lower end of the first wire guide, and the second wire guide can define a second channel hole at an upper end of the second wire guide. The upper end of the second wire guide can face the lower end of the first wire guide. The first channel hole and the second channel hole can be connected with each other.

In some implementations, the first wire guide can define (i) a guide hole that is open toward the equipment room, (ii) a door connection hole that is open toward a lower portion of the door, and (iii) a first channel hole. The guide hole, the door connection hole, and the first channel hole can be opened in different directions from one another.

In some implementations, the appliance can further include a side plate that is disposed at a side surface of the casing and disposed closer to the door than the wire guide. The side plate can protrude further from the side surface of the casing than from the wire guide or can form a continuous plane with the wire guide.

In some implementations, the side plate can include a plate recess part that is recessed toward the side surface of the casing. The plate recess part and the wire guide can define a continuous wire path.

In some implementations, the casing can include a guide bracket. The guide bracket can be configured to cover one end of the wire guide that is open toward the door.

In some implementations, the guide bracket can include a bracket body configured to cover the wire guide, and a mounting body that extends from the bracket body toward the door and is fixed to the casing. The mounting body can protrude further from a side surface of the casing than from the bracket body.

In some implementations, the casing can include a guide bracket. The guide bracket can be configured to cover an area where the first wire guide and the second wire guide are connected.

According to another aspect, an appliance can include: a casing having a storage space therein; an equipment room defined at an upper portion of the casing; a door disposed at a front of the storage space and configured to open and close at least a portion of the storage space; a wire configured to electrically connect the equipment room to the door; and a wire guide that is disposed at a side surface of the casing in a height direction of the casing and that is configured to store the wire.

### BRIEF DESCRIPTION OF THE DRAWINGS

FIG. 1 is a perspective view illustrating an example of a state in which an example of a home appliance is stored in furniture.

FIG. 2 is a perspective view illustrating an example of a home appliance.

FIG. 3 is a perspective view illustrating an example of a state in which a guide bracket is separated.

FIG. 4 is a perspective view illustrating an example of a state in which a wire guide is separated.

FIG. 5 is a perspective view illustrating an example of a wire cover constituting the wire guide being removed from a home appliance illustrated in FIG. 3.

FIG. 6 is a perspective view illustrating an example of configurations of a door and a wire of an example of a home appliance.

FIG. 7 is a perspective view illustrating an upper structure of the home appliance illustrated in FIG. 2.

FIG. 8 is a side view illustrating a side structure of the home appliance illustrated in FIG. 2.

FIG. 9 is an enlarged perspective view of a side upper structure of the home appliance illustrated in FIG. 3.

FIG. 10 is a perspective view illustrating a structure of an equipment room of an example of a home appliance.

FIG. 11 is an enlarged perspective view of a side center structure of the home appliance illustrated in FIG. 3.

FIG. 12 is a side view illustrating a side structure in a state in which a guide cover and a guide bracket are removed in an example of a home appliance.

FIG. 13 is an enlarged side view of an upper structure of FIG. 12.

FIG. 14 is an enlarged side view of a central structure of FIG. 12.

FIG. 15 is a perspective view illustrating a structure of a first wire guide of an example of a home appliance.

FIG. 16 is an exploded perspective view of a structure of a first wire guide of an example of a home appliance.

FIG. 17 is a perspective view illustrating a structure of a second wire guide of an example of a home appliance.

FIG. 18 is an exploded perspective view of a structure of a second wire guide of an example of a home appliance.

FIG. 19 is a perspective view illustrating a structure of a guide bracket of an example of a home appliance.

FIG. 20 is a perspective view illustrating an example of a home appliance.

FIG. 21 is a perspective view illustrating a wire guide of an example of a home appliance.

FIG. 22 is a perspective view illustrating a wire guide of an example of a home appliance.

FIG. 23 is a perspective view illustrating a wire guide of an example of a home appliance.

FIG. 24 is a perspective view illustrating a wire guide of an example of a home appliance.

FIG. 25 is a perspective view illustrating a wire guide of an example of a home appliance.

FIG. 26 is a perspective view illustrating a wire guide of an example of a home appliance.

### DETAILED DESCRIPTION

Hereinafter, one or more implementations of the present disclosure will be described in detail with reference to the illustrative drawings. When adding reference numerals to components in each drawing, it should be noted that identical components are given the same reference numerals as much as possible even if they are shown in different drawings. Additionally, in describing implementations of the present disclosure, if detailed descriptions of related known configurations or functions are judged to impede understanding of the implementations of the present disclosure, the detailed descriptions will be omitted.

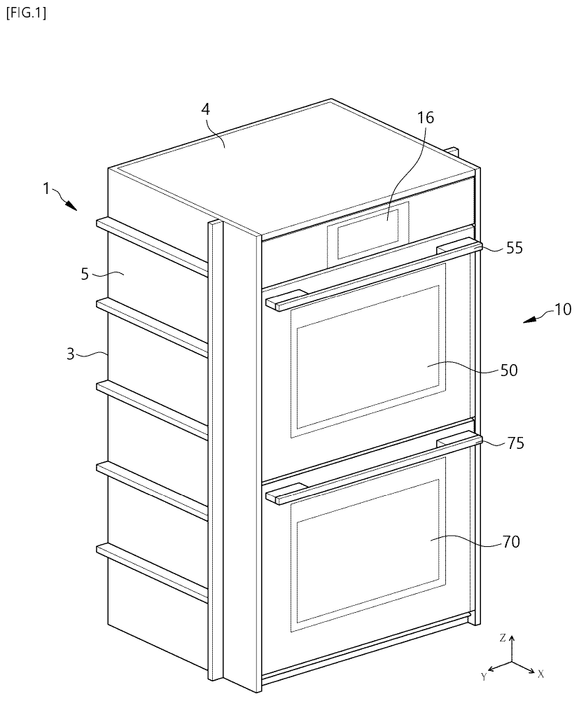

The present disclosure relates to a home appliance. Here, the home appliance can mean a device that has storage compartments therein, and the storage compartments are open and closed by doors 50 and 70. The doors 50 and 70 are disposed in front of the storage compartments and can serve to open and close the storage compartments. Here, “front” refers to the direction a user faces when the user is positioned in front of the home appliance. Referring to FIG. 1, the X-axis direction can be forward. The Y-axis direction can be the width direction of the home appliance. The Z-axis direction can be the height direction of the home appliance. Below, description will be made based on this direction.

The home appliance can include various home appliances such as cooking appliances, refrigerators, freezers, kimchi refrigerators, plant cultivation devices, stylers, and washing machines. Below, a cooking appliance among the home appliances will be described as an example.

In some implementations, the home appliance can be stored in a built-in manner in furniture. For example, the home appliance can be a cooking appliance installed in a built-in manner. Referring to FIG. 1, an example of a cooking appliance can be installed in a kitchen furniture 1 or the like so that only the front surface of the cooking appliance can be exposed forward. In this case, doors 50 and 70 and a display part 16 can be included in the front of the cooking appliance.

Referring to FIG. 1, the kitchen furniture 1 can include a lower structure 2, a rear surface portion 3, an upper surface portion 4, and a side surface portion 5. The home appliance can be surrounded by the rear surface portion 3, the upper surface portion 4, and the side surface portion 5 disposed on the bottom portion thereof, and only the front surface of the home appliance can be exposed forward. Since an area in which the home appliance is exposed forward is small, maintenance of an electronic component of the home appliance can also be performed in a narrow space.

In some implementations, the door includes of two doors 50 and 70, but it can also be applied to a home appliance provided with only one lower door 70. The following is an example of the application of the two doors 50 and 70 of the present disclosure to a cooking appliance. Also, among the two doors 50 and 70, the door placed relatively above is referred to an upper door 50, and the door placed below is referred to as a lower door 70.

In some examples, a first electronic component 90 can be disposed in an equipment room (S1 in FIG. 10). A second electronic component 100 can be disposed on the lower door 70, which is one of the doors 50 and 70. The first electronic component 90 and the second electronic component 100 can be electrically connected to each other through wire harnesses W1, W2a, and W2b. The first electronic component 90 can be a control part that controls the second electronic component 100. The first electronic component 90 can also control a display part 16 of the home appliance. As another example, the first electronic component 90 can be disposed on a side surface, a rear surface, or a bottom surface of the casing, not inside the equipment room S1. As another example, the equipment room S1 can be disposed under the casing.

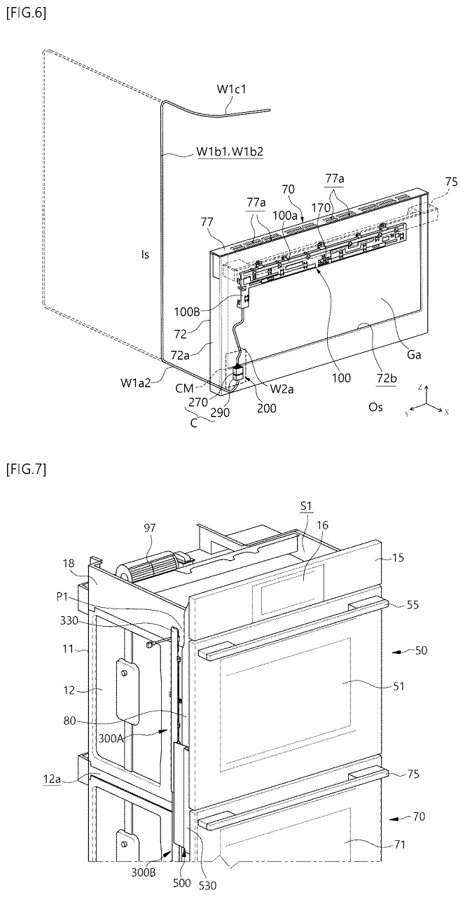

The second electronic component 100 can provide various functions to the doors 50 and 70. For example, when the second electronic component 100 is an image acquisition module 100, an image sensing device 170 (see FIG. 6) can be provided in the image acquisition module 100 to acquire internal images of the storage compartment. A lighting device can be provided in the doors 50 and 70 to increase illuminance of the storage compartment.

As another example, a display device can be disposed on the doors 50 and 70 as the second electronic component 100. The display device can provide information on the home appliance to a user. The user can input an operation command through the display device.

A portion of the image acquisition module 100 or the display device can be disposed at the doors 50 and 70. The second electronic component 100, such as the image acquisition module 100 or the display device, can exchange an electrical signal with the first electronic component 90 provided in the home appliance main body or can be connected to the main body through wire harnesses W1, W2a, and W2b for power supply. Hereinafter, the image acquisition module 100 will be described as an example of the second electronic component 100.

The second electronic component 100 can be disposed inside the doors 50 and 70. The wire harnesses W1, W2a, and W2b connected to the second electronic component 100 can exit the doors 50 and 70 and can be connected to the first electronic component 90. Among the total lengths of the wire harnesses W1, W2a, W2b, a section connected from the doors 50 and 70 to the equipment room S1 can be disposed outside the side surface of the casing, to be described below.

As another example, the second electronic component 100 can be disposed only in one of the upper door 50 and the lower door 70. As another example, among the components constituting the second electronic component 100, the image acquisition module 100 and the lighting device can be divided and disposed in the upper door 50 and the lower door 70.

As another example, the second electronic component 100 can be disposed outside the lower door 70 rather than inside thereof. For example, the second electronic component 100 can be disposed on the upper surface, the lower surface, the front surface, the rear surface, the side surface, or a second handle 75 of the lower door 70.

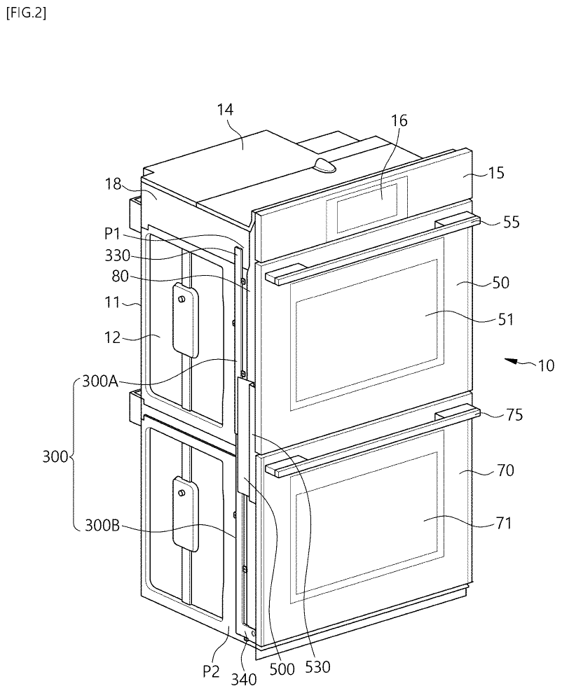

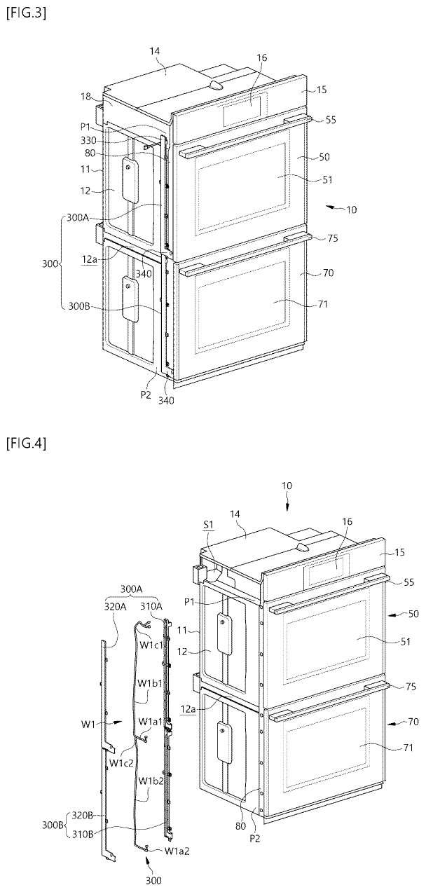

In some examples, a part of the wire harnesses W1, W2a, and W2b connected from the doors 50 and 70 to the equipment room S1 can be disposed along a wire guide 300. In FIGS. 2 and 3, the wire guide 300 disposed on a side surface of the casing is illustrated. In some implementations, the wire guide 300 can include two wire guides 300A and 300B. The wire guide 300 will be described again below.

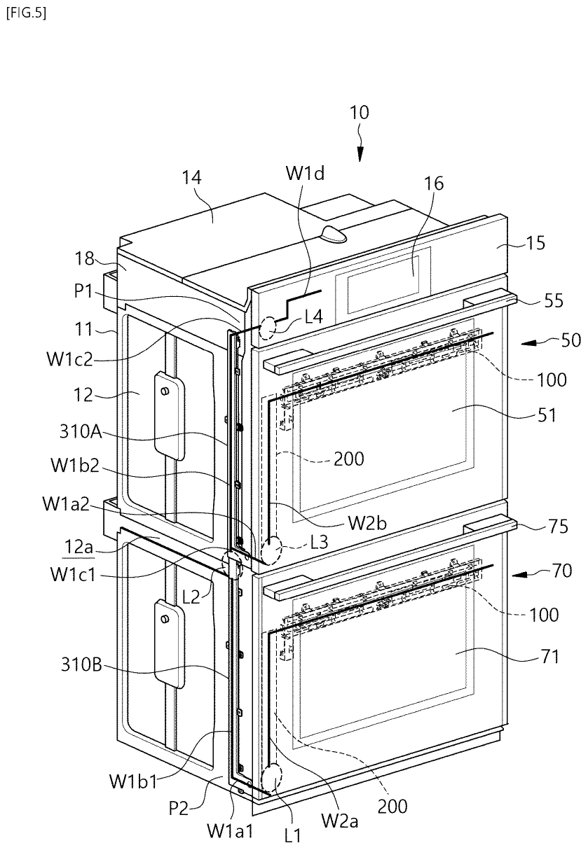

For convenience of description, the wire harnesses W1, W2a and W2b will be described first. The wire harnesses W1, W2a and W2b can include a connection wire W1 and door wires W2a and W2b. Referring to FIG. 4, the connection wire W1 can include upper wires W1a1, W1b1, and W1c1 and lower wires W1a2, W1b2, and W1c2. The upper wires W1a1, W1b1, and W1c1 can include a first door connection part W1a1, a first extension part W1b1, and an equipment room connection part W1c1. The lower wires W1a2, W1b2, and W1c2 can include a second door connection part W1a2, a second extension part W1b2, and a wire connection part W1c2. It can be seen that the first door connection part W1a1, the first extension part W1b1, and the equipment room connection part W1cl divide one component connected to each other for convenience. It can be seen that the second door connection part W1a2, the second extension part W1b2, and the wire connection part W1c2 also divide one component connected to each other for convenience.

Looking at the door wires W2a and W2b with reference to FIG. 5, the door wires W2a and W2b include a first door wire W2a disposed on the upper door 50 and a second door wire W2b disposed on the lower door 70. The first door wire W2a and the second door wire W2b can be configured separately from each other. The first wire door W2a can connect the second electronic component 100 disposed on the upper door 50 and the upper wires W1a1, W1b1, and W1c1. The second wire door W2b can connect the second electronic component 100 disposed in the lower door 70 and the lower wires W1a2, W1b2, and W1c2.

As another example, the upper wires W1a1, W1b1, and W1c1 and the lower wires W1a2, W1b2, and W1c2 constituting the connection wire W1 can be integrated. As another example, the connection wire W1 and the door wires W2a, W2b can be integrated.

The wire harnesses W1, W2a, W2b can be connected to each other through connectors. Looking at FIG. 5, a total of four connection points can be seen from bottom to top. Each wire constituting the wire harness W1, W2a, and W2b can be coupled at connection points.

In this case, the wires can be coupled by the connectors. At the first connection point L1, the second door wire W2b connected to the lower door 70 and the lower wires W1a2, W1b2, and W1c2 can be connected. At the second connection point L2, the lower wires W1a2, W1b2, and W1c2 and the upper wires W1a1, W1b1, and W1c1 can be connected. At the third connection point L3, the first door wire W2a connected to the upper door 50 and the upper wires W1a1, W1b1, and W1c1 can be connected. At the fourth connection point L4, the upper wires W1a1, W1b1, and W1cl and the component wire W1d can be connected.

Hereinafter, the home appliance will be described, focusing on the structure for mounting and protecting the wire harnesses W1, W2a, and W2b in the casing. Referring to FIG. 2, a rear cover 11, side cover 12, and upper cover 14 that constitute the cooking appliance can form the casing of the main body 10. A casing constituting the storage compartment can be provided inside the rear cover 11, the side cover 12, and the upper cover 14. The casing can also be viewed as a type of inner casing. In FIG. 3, reference numeral 12a denotes a recess part provided in the center of the side cover 12. Based on the recess part 12a, the side cover 12 can be divided into an upper part and a lower part.

An upper panel 15 can be provided on the upper part of the cooking appliance. The upper panel 15 can be disposed on the front upper part of the cooking appliance. The upper panel 15 can be provided with a display part 16. The display part 16 can serve to operate a function of the cooking appliance and display a status of the cooking appliance. The display part 16 can be configured as a display capable of touch operation. As another example, the display part 16 can be omitted from the upper panel 15 and the display part can be placed on the doors 50 and 70.

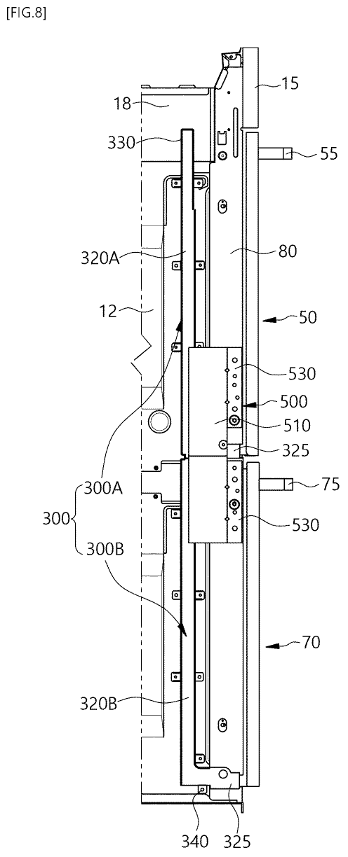

Referring to FIG. 7, an equipment room S1 can be disposed at the rear of the upper panel 15. The equipment room S1 can be a space partitioned from the storage compartment. In some implementations, the equipment room S1 can be placed between the upper cover 14 and an upper casing 18. The upper casing 18 can be placed on the upper portion of the side cover 12. The upper casing 18 can be arranged around the side of the equipment room S1.

The upper door 50 can be placed on the front of the casing. The lower door 70 can be placed on the front of the casing at a different height from the upper door 50. In some implementations, the upper door 50 and the lower door 70 can each be operated in a kind of pull-down method in which the upper end rotates up and down around the lower end. As another example, the upper door 50 and the lower door 70 can each be operated in a side swing manner.

Looking at the upper door 50, the front 51 of the upper door 50 can have a structure that allows an upper storage compartment 31 to be seen through. For example, the front 51 of the upper door 50 has a panel structure made of glass, so that a user can observe the inside of the storage compartment through the upper door 50. As another example, the front 51 of the upper door 50 can be made of a dark material or coated with a separate film so that the storage compartment is not visible from the outside. Reference numeral 55 denotes a first handle for opening and closing the upper door 50.

The lower door 70 can be placed below the upper door 50. The lower door 70 can be placed at the front lower part of the casing. The storage compartment can be seen through the front of the lower door 70. The user can observe the inside of the storage compartment through the front of the lower door 70.

Referring to FIG. 6, in some implementations, a transparent part can be provided at the center of the lower door 70. The transparent part is for viewing the storage compartment from the outside, and can be made of a transparent material. The transparent part can be viewed as a part of a front panel Ga constituting the front of the lower door 70. The transparent part can be provided at the center of the front panel Ga. For example, the edge portion of the front panel Ga can be made of a material with high surface roughness, unlike the transparent part. Alternatively, a separate opaque film can be applied to the edge of the front panel Ga. In this case, the edge portion of the front panel Ga, excluding the transparent portion, may not be visible through the storage compartment.

As another example, the edge of the front panel Ga outside of the transparent part can be covered by a door frame 72. Here, the outside of the transparent part can mean an edge portion of the front panel Ga disposed around the edge of the transparent part.

As another example, the lower door 70 can be made of a dark material or coated with a separate film so that the storage compartment is not visible from the outside. As another example, a transparent door panel can be omitted in the lower door 70, and an opaque metal or non-metal plate can form the front surface. Even in this case, the storage compartment may not be visible from the outside.

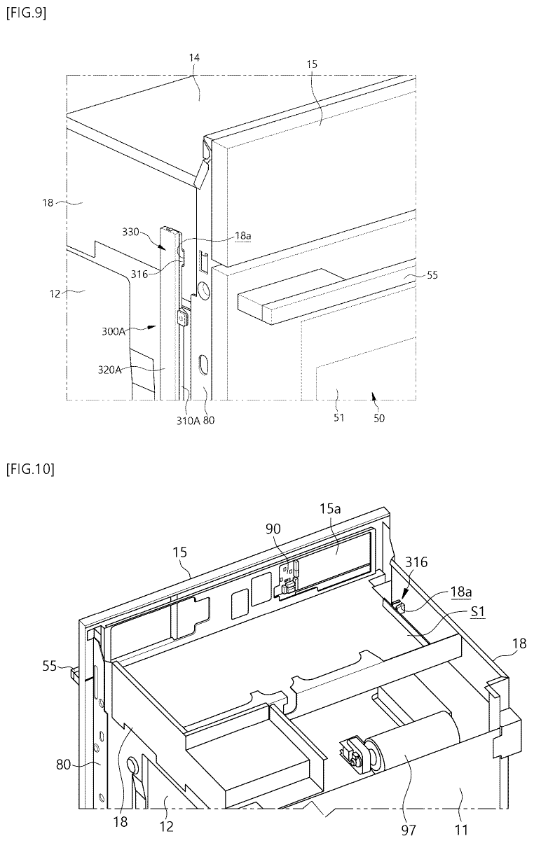

Looking at FIGS. 7 and 8, a side plate 80 can be provided on the side surface of the casing. The side plate 80 can be disposed on the front side of the casing close to the side of the doors 50 and 70. As shown in FIG. 8, In some implementations, the side plate 80 can be placed in the front of the side cover 12. Additionally, the side plate 80 can be disposed behind the doors 50 and 70. The side plate 80 can extend long in the height direction of the casing so as to be adjacent to both the upper door 50 and the lower door 70. Referring to FIG. 9, the side plate 80 can be provided higher than the adjacent wire guide 300. A guide bracket 500, which will be described below, can be fixed to the side plate 80.

The side plate 80 can have a flat structure made of metal. The side plate 80 can serve to align the left and right sides of the main body 10 so that they are not misaligned when the main body 10 is stored in the furniture 1. To this end, the side plate 80 can protrude from the side cover 12. The side plate 80 can protrude further from the side of the casing than the wire guide 300, or can form a continuous plane with the wire guide 300.

The side plate 80 can be disposed closer to the doors 50 and 70 than the wire guide 300. In this way, when the main body 10 is stored in the furniture 1, the side plate 80 can cover the wire guide 300 so that the wire guide 300 is not visible from the front. As another example, the side plate 80 can be omitted. As another example, the side plate 80 can be integrally formed with the side cover 12 constituting the casing.

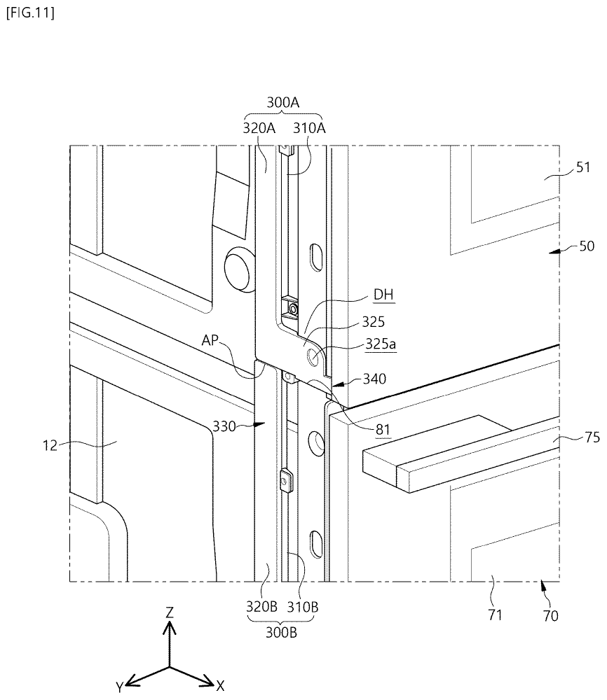

Looking at FIGS. 11 and 14, the side plate 80 can be provided with a plate recess part 82. The plate recess part 82 can be formed by a portion of the side plate 80 being recessed toward the side surface of the casing. The plate recess part 82 can form a continuous wire path together with the wire guide 300. Referring to FIG. 14 in which the guide bracket 500 is removed, the plate recess part 82 of the side plate 80 is exposed to the outside. Wire harnesses W1, W2a, and W2b can be placed in the plate recess part 82. The plate recess part 82 can be covered by the guide bracket 500.

As shown in FIG. 10, the equipment room S1 can be provided on the upper part of the main body 10. The equipment room S1 can be placed below the upper cover 14. The equipment room S1 can be formed at a position corresponding to a lower portion of the upper cover 14, the rear side of the upper panel 15, and between the upper casing 18 disposed on both sides. As another example, the equipment room S1 can be disposed on the side, back, or bottom of the main body 10.

The first electronic component 90 and a cooling fan 97 can be placed in the equipment room S1. The cooling fan 97 can serve to lower the temperature of the main body 10 by drawing in and circulating external air. A cooling duct, which is a flow path for air flowing by the cooling fan 97, can be disposed in the equipment room S1.

The first electronic component 90 can include a control part that controls the display part 16 and the second electronic component 100. Referring to FIG. 10, the first electronic component 90 can be composed of a substrate. A plurality of electrodes 92 can be disposed on the substrate. The display part 16 and a knob can be disposed in front of the substrate.

Referring to FIGS. 9 and 10, a through hole 18a can be provided in the upper casing 18. The through hole 18a can be formed to pass through the upper casing 18. The through hole 18a can expose the equipment room S1 to the outside. A guide hole OH of the wire guide 300, to be described below, can be connected to the through hole 18a. In FIG. 10, reference numeral 316 denotes a guide arm of the wire guide 300. The guide arm 316 can pass through the through hole 18a and can be inserted into the equipment room S1. The guide hole OH can be provided inside the guide arm 316.

In some examples, the second electronic component 100 and the door wire W2a and W2b can be disposed on the doors 50 and 70. The second electronic component 100 disposed on the two doors 50 and 70 can be configured identically to each other. As another example, different types of second electronic component 100 can be disposed on the two doors 50 and 70, respectively. For example, a lighting device can be disposed on the upper door 50, and an image sensing device 170 for photographing an image can be disposed on the lower door 70. Hereinafter, it will be described that the second electronic component 100 is an image acquisition module as an example.

The second electronic component 100 disposed in the lower door 70 will be described with reference to FIG. 6. First, in FIG. 6, the reference numeral Is denotes an inward direction toward the main body 10, and Os denotes an outward direction away from the main body 10.

A connector module 200 can be provided under the lower door 70. The connector module 200 can connect the second door wire W2b and the second door connection part W1a2 of the lower wires W1a2, W1b2, and W1c2. The connector module 200 can include a connector assembly C in which two connectors 270 and 290 are assembled. In some cases, an operator can separate the second door wire W2b from the second door connection part W1a2 of the lower wires W1a2, W1b2, and W1c2 from the connector module 200, and maintain/repair the second electronic component 100. For reference, in FIG. 6, the image acquisition module 100 as the second electronic component 100 is represented in a see-through state, but the image acquisition module 100 can be shielded by an edge part of the front panel Ga (see FIG. 6).

As shown in FIG. 6, the door connector 270 constituting the connector module 200 can be assembled with the counterpart connector 290. The door connector 270 can be connected to the second door wire W2b. The counterpart connector 290 can be connected to the second door connection part W1a2 of the lower wires W1a2, W1b2, and W1c2. When the two connectors 270 and 290 are coupled to each other, the lower wires W1a2, W1b2, and W1c2 can be electrically connected to the second door wire W2b. In another example, the two connectors 270 and 290 can be omitted, and the connection wire W1 and the second door wire W2b can be directly connected to each other. In another example, the connection wire W1 and the second door wire W2b can be integrally formed.

The connector module 200 can be disposed in a connector storage part CM. The connector storage part CM can be disposed in an installation area provided inside the lower door 70. The connector storage part CM can be viewed as an empty space that is a part of the installation area. As another example, the connector storage part CM can be a bracket formed integrally with the installation area or separately.

As shown in FIG. 6, the connector storage part CM can be disposed adjacent to a lower end portion of a side surface of the lower door 70. When the connector storage part CM is disposed at the lower end portion of the lower door 70, the operator can access the connector module 200 through the lower portion of the lower door 70. When the connector storage part CM is disposed at the lower end portion of the lower door 70, the connector module 200 may not be exposed to the outside normally. Also, since an inlet of the connector storage part CM is open to the lower end portion of the lower door 70, the operator can easily access the connector module 200.

As another example, the connector storage part CM can be disposed adjacent to the upper end of the side surface of the lower door 70. Also, the inlet of the connector storage part CM can be open to the side surface of the lower door 70.

A frame of the lower door 70 can be formed by the door frame 72. The door frame 72 can include a frame body 72a having an approximately rectangular frame shape. A through part 72b, which is a kind of empty space, can be open at the center of the frame body 72a. The front panel Ga can be disposed at the through part 72b. Reference numeral 77a denotes a frame discharge port, and the frame discharge port 77a can be an outlet through which air having passed through a cooling passage formed in the lower door 70 is discharged to the outside.

As shown in FIG. 6, the second electronic component 100 can include a main unit 100A and a connection unit 100B. The main unit 100A can include an image sensing device 170. The connection unit 100B can create a path through which the second door wire W2b is guided to the main unit 100A.

Referring to FIG. 5, the first electronic component 90 can be transferred to the second electronic component 100 disposed in the lower door 70. Specifically, the signal or power of the first electronic component 90 can be transferred in the order of component wire W1d-the fourth connection point L4-the upper wires W1a1, W1b1, W1c1-the second connection point L2-the lower wires W1a2, W1b2, W1c2-the first connection point L1-the connector module 200-the second door wire W2b-the second electronic component 100.

The first electronic component 90 can also be transferred to the second electronic component 100 disposed in the upper door 50. Specifically, the signal or power of the first electronic component 90 can be transferred in the order of component wire W1d-fourth connection point L4-upper wires W1a1, W1b1, W1c1-third connection point L3-connector module 200-first door wire W2a-second electronic component 100.

As shown in FIG. 6, the second door connection part W1a2 can be disposed in the front-rear direction (X-axis direction). The second door connection part W1a2 can extend rearward from the counter connector 290 along the lower portion of the main body 10. The equipment room connection part W1c1 can extend in the direction of the equipment room S1 from the upper end of the first extension part W1b1, and in some examples, a part of the component wire W1d can extend in the left-right direction (Y-axis direction). For reference, in FIG. 6, the first extension part W1b1 and the second extension part W1b2 are continuously connected to each other for better understanding, but the first extension part W1b1 and the second extension part W1b2 can be connected to each other by a connector.

The connection wire W1 including the first extension part W1b1 and the second extension part W1b2 can extend in the height direction (Z-axis direction) of the main body 10. In this case, the first extension part W1b1 and the second extension part W1b2 can be disposed on a side surface of the casing. Since the connection wire W1 including the first extension part W1b1 and the second extension part W1b2 is disposed on a side surface of the casing, the overall length can be reduced as compared with that of the connection wire W1 connected to the first electronic component 90 via the rear side of the main body 10. In FIG. 6, the dotted line illustrates a path when the connection wire W1 rotates around the rear surface of the main body 10 and enters the equipment room S1. Comparing them, the first extension part W1b1 and the second extension part W1b2 are disposed closer to the front surface of the main body 10, that is, the doors 50 and 70, than the rear surface of the main body 10, and thus, the connection wire W1 may not extend to the rear surface of the main body 10. Accordingly, the entire length of the connection wire W1 is shortened, and noise mixed with the signal can be reduced.

In some examples, since the first extension part W1b1 and the second extension part W1b2 are disposed on the side surface of the casing, they can be more directly affected by heat diffused from the surface of the casing as compared with the second door connection part W1a2 or the equipment room connection part W1c1. Therefore, the connection wire W1, including the first extension part W1b1 and the second extension part W1b2, can be blocked from the surface of the casing. The blocking between the connection wire W1 and the surface of the casing can be performed by the wire guide 300.

Referring to FIGS. 7 and 8, a state in which the wire guide 300 is disposed on the side cover 12 is illustrated. The wire guide 300 can block laterally between the side cover 12 and the connection wire W1. The wire guide 300 can block a flow of heat transferred to the connection wire W1 on the surface of the side cover 12. In particular, in some examples, the wire guide 300 can surround the first extension part W1b1 and the second extension part W1b2 to protect the first extension part W1b1 and the second extension part W1b2 from a high temperature environment.

Here, blocking laterally means that the surface of the casing and the connection wire W1 do not face each other directly. In this case, radiant heat generated from the surface of the casing may not be directly transferred to the connection wire W1. As another example, the connection wire W1 can be disposed on the surface of the casing disposed inside the casing so that radiant heat generated from the surface of the casing is not directly transferred to the connection wire W1.

As shown in FIG. 7, the wire guide 300 can be disposed on the surface of the side cover 12. The wire guide 300 can surround the connection wire W1 so that the connection wire W1 is not exposed to the outside. More specifically, the wire guide 300 can surround the first extension part W1b1 and the second extension part W1b2 of the connection wire W1. Guide covers 320A and 320B can cover the first extension part W1b1 and the second extension part W1b2 while the first extension part W1b1 and the second extension part W1b2 are stored in the guide channel 312 of the wire guide 300.

Referring to FIG. 5, a state in which the guide covers 320A and 320B are removed is illustrated. As shown, the first extension part W1b1 and the second extension part W1b2 can be stored in guide bases 310A and 310B constituting the wire guide 300.

The wire guide 300 can be disposed between a first point P1 entering the inside of the electronic component S1 and a second point P2 entering the doors 50 and 70. When the wire guide 300 is disposed between the first point P1 and the second point P2, both ends of the connection wire W1 can be naturally guided to the lower door 70 and the electronic component S1, respectively. Here, the second point P2 refers to a space between a lower portion of the lower door 70 and a lower portion close to a bottom of the main body 10. The first point P1 refers to an upper portion of the main body 10 close to the upper casing 18.

The wire guide 300 can be disposed along a straight path between the first point P1 and the second point P2. In the some implementations, the first point P1 and the second point P2 are spaced apart from each other in the height direction (Z-axis direction) of the main body 10. Accordingly, the wire guide 300 can be provided in the height direction of the main body 10. The first extension part W1b1 and the second extension part W1b2 of the connection wire W1 can also be disposed along a straight path between the first point P1 and the second point P2 along the wire guide 300. The straight path can be the shortest distance connecting the first point P1 and the second point P2.

The wire guide 300 can be disposed adjacent to the side plate 80. The wire guide 300 can be disposed at a position recessed rearward from the doors 50 and 70 than the side plate 80. Accordingly, when viewed from the front of the main body 10, the wire guide 300 can be covered by the side plate 80.

The wire guide 300 can be disposed closer to the front than the rear of the main body 10. That is, the wire guide 300 can be disposed closer to the doors 50 and 70 than the rear cover 11. In this case, compared to the wire guide 300 being disposed close to the rear cover 11, the length of the wire guide 300 and the connection wire W1 disposed on the wire guide 300 can be relatively shortened. In some implementations, the wire guide 300 is disposed closer to the doors 50 and 70 than the side center of the casing.

The wire guide 300 can include a plurality of wire guides 300A and 300B. Referring to FIG. 8, the first wire guide 300A and the second wire guide 300B arranged at a different height from the first wire guide 300A are provided. The second wire guide 300B can form a continuous guide path with the first wire guide 300A, and the connection wire W1 can be arranged along the guide path. The first wire guide 300A and the second wire guide 300B can have similar shapes. In this way, the plurality of wire guides 300A, 300B can also insulate wire W1, W2 provided in a high home appliance.

The first wire guide 300A can be disposed adjacent to the upper door 50. The second wire guide 300B can be disposed adjacent to the lower door 70. One end of the first wire guide 300A and the second wire guide 300B can be disposed in contact with each other. In FIG. 10, reference numeral AP indicates a contact portion where the first wire guide 300A and the second wire guide 300B are in close contact with each other. As another example, the first wire guide 300A and the second wire guide 300B can be arranged to be spaced apart from each other.

Referring to FIG. 9, a first guide part 330 can be provided at the upper end of the first wire guide 300A. The first guide part 330 can be provided with a guide arm 316. The guide arm 316 can be inserted into the through hole 18a open in the upper casing 18. The equipment room connection part W1c1 constituting the upper wires W1a1, W1b1, and W1cl are guided by the guide arm 316 and can enter the inside of the through hole 18a. The equipment room connection part W1c1 can be connected to the component wire W1d at the fourth connection point L4 (see FIG. 5).

Referring to FIG. 11, a second guide part 340 can be provided at the lower end of the first wire guide 300A. The second guide part 340 can extend forward. More precisely, the second guide part 340 of the first wire guide 300A can extend in the direction of the upper door 50. In this way, the first guide part 330 and the second guide part 340 can extend in different directions. The first door connection part W1a1 of the upper wires W1a1, W1b1, and W1c1 are guided to the lower part of the upper door 50 along the second guide part 340 extending in the direction of the upper door 50.

In this case, the plate recess part 82 of the side plate 80 can form a continuous wire path together with the second guide part 340. Looking at FIG. 10 in a state in which the guide bracket 500 is removed, the plate recess part 82 can be covered by the second guide part 340. The first door connection part W1a1 can be stored inside the first wire guide 300A through plate recess part 82.

In some implementations, the guide covers 320A and 320B can protrude further than the guide bases 310A and 310B constituting the second guide part 340. Accordingly, the guide bases 310A and 310B do not overlap the plate recess part 82, and the guide covers 320A and 320B can cover the upper part of the plate recess part 82. This structure can prevent the side of the casing from becoming thick.

As shown in FIG. 11, the second wire guide 300B can be disposed below the first wire guide 300A. The second guide part 340 of the first wire guide 300A can be arranged continuously with the first guide part 330 of the second wire guide 300B. In this way, the upper wires W1a1, W1b1 and W1c1 and the lower wires W1a2, W1b2 and W1c2 can be sequentially arranged along the second guide part 340 of the first wire guide 300A and the first guide part 330 of the second wire guide 300B.

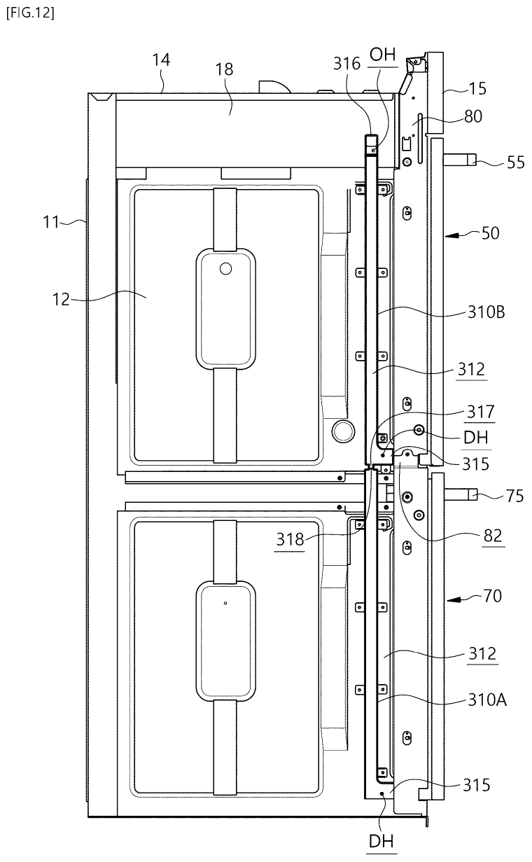

Looking at FIG. 12, a state in which the guide covers 320A and 320B of the wire guide 300 are removed is illustrated. When the guide covers 320A and 320B are removed, the guide channel 312 formed in the first wire guide 300A and the guide channel 312 provided in the second wire guide 300B can be open, respectively. The two guide channels 312 can be connected to each other to form one guide path extending in the vertical direction.

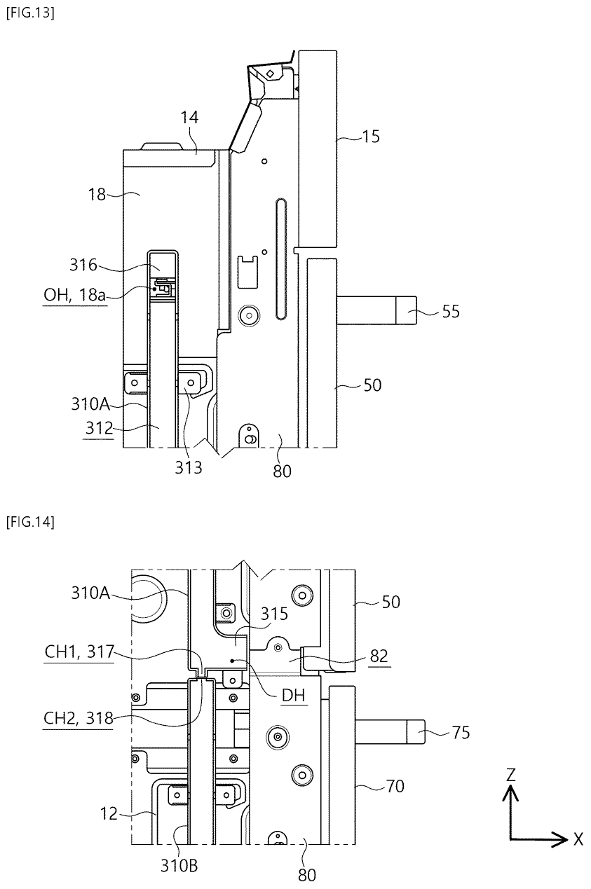

Looking at FIG. 13, the upper view of the first wire guide 300A is illustrated. The guide arm 316 of the first wire guide 300A can be provided around the guide hole OH. The guide hole OH can be formed through the guide bases 310A, 310B. The guide hole OH can be connected to the through hole 18a of the side plate 80. The equipment room connection part W1c1 of the upper wires W1a1, W1b1, and W1c1 can enter the inside of the equipment room S1 through the guide hole OH and the through hole 18a.

FIG. 14 illustrates the part where the lower part of the first wire guide 300A and the upper part of the second wire guide 300B meet, that is, the central part of the side cover 12. As shown, a first channel hole CH1 can be open downward at the lower part of the first wire guide 300A. At the upper part of the second wire guide 300B facing the lower part of the first wire guide 300A, there is a second channel hole CH2 connected to the first channel hole CH1 in the vertical direction (Z-axis direction) can be open upward. The wire harnesses W1, W2a, and W2b can be sequentially stored through the first channel hole CH1 and the second channel hole CH2 connected to each other.

In some examples, FIG. 14 illustrates the plate recess part 82 of the side plate 80 forming a continuous wire path together with the second guide part 340 of the first wire guide 300A. The plate recess part 82 and the second guide part 340 can be connected to each other in the left and right direction (X-axis direction) based on the drawing. The first door connection part W1a1 constituting the upper wires W1a1, W1b1, W1cl can be stored inside the first wire guide 300A via the plate recess part 82.

Next, the structure of the wire guide 300 will be described in detail. In some implementations, the wire guide 300 can include a first wire guide 300A and a second wire guide 300B. The first wire guide 300A accommodates wire harnesses W1, W2a, and W2b connecting the first electronic component 90 of the equipment room S1 and the second electronic component 100 of the upper door 50. More precisely, the first wire guide 300A can accommodate the upper wires W1a1, W1b1, W1c1 of the connection wire W1. The second wire guide 300B accommodates wire harnesses W1, W2a, W2b connecting the first electronic component 90 of the equipment room S1 and the second electronic component 100 of the lower door 70. More precisely, the second wire guide 300B can accommodate the lower wires W1a2, W1b2, W1c2 of the connection wire W1.

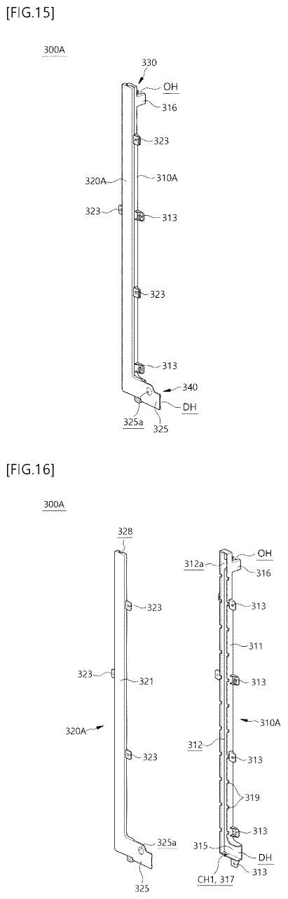

The first wire guide 300A is shown in FIGS. 15 and 16. Referring to FIGS. 15 and 16, the first wire guide 300A can include a first guide part 330 extending toward the equipment room S1 where the first electronic component 90 is disposed and a second guide part 340 provided on the other side of the first guide part 330. The second guide part 340 can extend toward the upper door 50. In this way, the first guide part 330 and the second guide part 340 can extend in different directions.

Referring to FIG. 16, the first wire guide 300A can include a guide base 310A and a guide cover 320A. The guide base 310A can be disposed on a side of the casing, that is, on the surface of the side cover 12. The guide base 310A can be provided with a guide channel 312. The guide channel 312 can be provided between the bottom part of the guide base 310A and a pair of fence parts 311 provided on both sides of the bottom part. The wire harness W1, W2a, W2b can be stored in the guide channel 312. More precisely, the upper wires W1a1, W1b1, W1c1 constituting the wire harnesses W1, W2a, W2b can be stored in the guide channel 312.

The guide channel 312 can be open in a direction opposite to the surface direction of the side cover 12. The open portion of the guide channel 312 can be shielded by the guide cover 320A. The operator can assemble the guide cover 320A to the guide base 310A after storing the wire harnesses W1, W2a, and W2b in the guide channel 312.

The fence part 311 can be provided with a plurality of base fastening pieces 313. The base fastening pieces 313 can protrude from the fence part 311 and come into close contact with the side cover 12. The base fastening pieces 313 can be parts to which fasteners such as screws are fastened. Some of the base fastening pieces 313 can be fastened with fasteners while overlapping with cover fastening pieces 323 provided on the guide cover 320A.

A guide hole OH and a door connection hole DH can be open at both ends of the guide channel 312, respectively. The guide hole OH can be open toward the equipment room S1. The guide hole OH can be open between the pair of guide arms 316. The guide hole OH can be connected to a channel end 312a formed at the upper end of the guide channel 312. The guide arm 316 can pass through the through hole 18a and connect the guide hole OH and the through hole 18a.

The guide base 310A can be provided with a base extension part 315 extending in the direction of the doors 50 and 70. The guide channel 312 can be connected to the base extension part 315. A door connection hole DH open toward a lower portion of the door 50 can be provided at an end portion of the base extension part 315. The base extension part 315 can form the second guide part 340 together with a cover extension part 325, which will be described later.

The door connection hole DH can be open toward the lower portion of the doors 50 and 70. The door connection hole DH can be open in a direction different from the guide hole OH. In some examples, if the guide hole OH is open in the left and right width directions (Y-axis direction in FIG. 1) of the main body 10, the door connection hole DH can be open in the front-back direction (X Y-axis direction in FIG. 1) of the main body 10.

A first channel hole CH1 can be open in the lower part of the guide base 310A. The first channel hole CH1 can be open in the longitudinal direction of the guide base 310A, that is, in the height direction of the main body (Z-axis direction in FIG. 1). As a result, the guide hole OH, the door connection hole DH, and the first channel hole CH1 can each be open in different directions. The first channel hole CH1 can be connected to a second channel hole CH2 of the second wire guide 300B.

Reference numeral 319 denotes a base groove recessed in the fence part 311. The base grooves 319 can be provided at regular intervals along the longitudinal direction of the fence part 311. The base groove 319 can allow the guide base 310A to bend more easily in the direction of the side cover 12. If the flexibility of the guide base 310A is increased by the base groove 319, the first wire guide 300A can be more easily mounted on the side cover 12.

Looking at the guide cover 320A, the guide cover 320A can have a similar shape to the guide base 310A. The guide cover 320A can be coupled to the guide base 310A to form the exterior of the first wire guide 300A. A cover body 321 of the guide cover 320A can have a flat structure that covers the guide channel 312. The cover body 321 can be viewed as defining the guide channel 312 together with the guide base 310A.

The cover body 321 can be provided with a plurality of cover fastening pieces 323. The cover fastening pieces 323 can be fastened with a fastener while overlapping some of the base fastening pieces 313. As another example, the base fastening pieces 313 and the cover fastening pieces 323 can be omitted, and the fastener can pass through the bottom of the guide base 310A. As another example, the first wire guide 300A can be attached to the surface of the side cover 12 with adhesive.

A cover extension part 325 can be provided at the lower part of the guide cover 320A. The cover extension part 325 can extend from the guide cover 320A toward the upper door 50 and cover the base extension part 315. The cover extension part 325 can form the door connection hole DH together with the base extension part 315.

In some implementations, the cover extension part 325 can extend longer than the base extension part 315. More precisely, as shown in FIG. 14, the guide base 310A does not overlap with the plate recess part 82, and as shown in FIG. 10, only the guide cover 320A can cover the upper portion of the plate recess part 82. This structure can prevent the side of the casing from becoming thick. Reference numeral 325a denotes a cover fastening hole for fastening the guide cover 320A to the side plate 80.

A cover hole 328 can be open at the upper end of the guide cover 320A. The cover hole 328 allows the upper part of the first wire guide 300A to be open upward. The cover hole 328 can create the second channel hole CH2. The first wire guide 300A may not have the second channel hole CH2, but when the cover hole 328 is provided, the guide cover 320A of the first wire guide 300A and guide cover 320A of the second wire guide 300B can be shared.

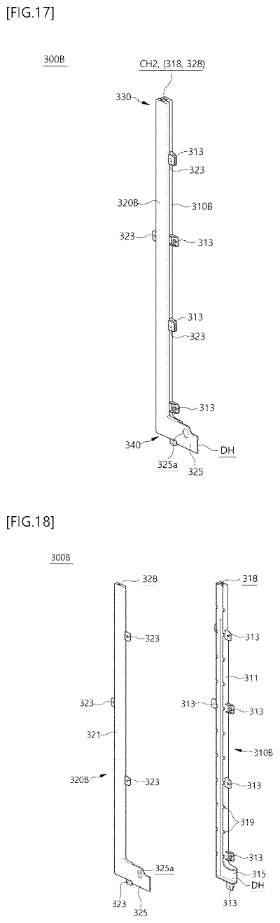

Next, the second wire guide 300B will be described with reference to FIGS. 17 and 18. Since the structure of the second wire guide 300B is similar to that of the first wire guide 300A, the parts that are different from the first wire guide 300A will be mainly described, and the remaining parts will be given the same reference numerals and detailed descriptions will be omitted.

The second wire guide 300B can include a first guide part 330 extending toward the equipment room S1 where the first electronic component 90 is disposed and a second guide part 340 provided on the other side of the first guide part 330. The first guide part 330 can be viewed as facing the second guide part 340 of the first wire guide 300A. The second guide part 340 of the second wire guide 300B can extend toward the lower door 70. In this way, the first guide part 330 and the second guide part 340 can extend in different directions.

The guide arm 316 can be omitted from the guide base 310B constituting the second wire guide 300B. The base hole 318 for forming the second channel hole CH2 can be open at the upper end of the guide base 310B. The base hole 318 can cooperate with the cover hole 328 of the guide cover 320B to create the second channel hole CH2. The second channel hole CH2 can be connected to the first channel hole CH1 of the first wire guide 300A. The wire harnesses W1, W2a, W2b can be sequentially arranged through the first channel hole CH1 and the second channel hole CH2.

Next, looking at the guide bracket 500, the guide bracket 500 can be disposed on the surface of the casing. Referring to FIGS. 7 and 8, the guide bracket 500 can be fixed to the surface of the side cover 12. The guide bracket 500 can extend rearward, that is, toward the rear cover 11, from a position adjacent to the doors 50 and 70. A portion of the guide bracket 500 can cover the wire guide 300.

The guide bracket 500 can align the main body 10 so that the insertion posture of the main body 10 is not distorted when the main body 10 is stored in the furniture 1. For this purpose, the guide brackets 500 can be provided on both sides of the main body 10, respectively. Since the guide bracket 500 covers the wire guide 300, it is possible to prevent the wire guide 300 from being damaged by colliding with the furniture 1.

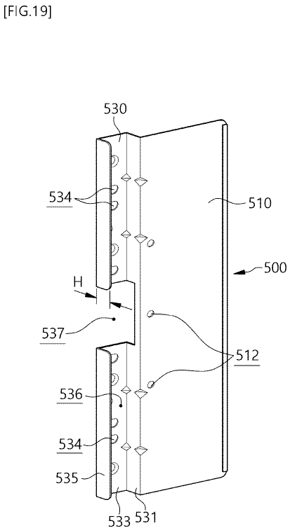

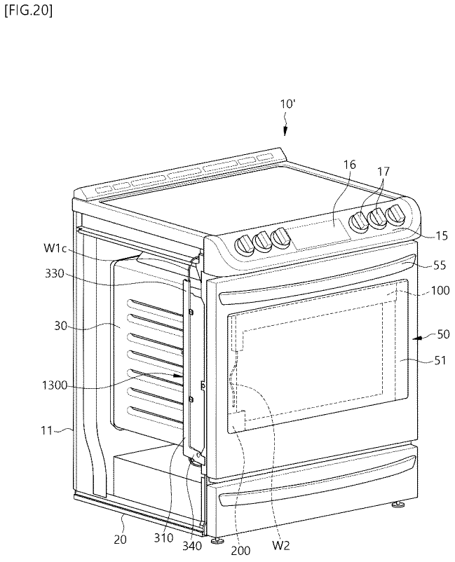

FIG. 19 illustrates the structure of the guide bracket 500. The guide bracket 500 can have a thin plate structure. The guide bracket 500 can be made by bending a metal material several times. The guide bracket 500 can have a structure that protrudes from the side plate 80 through a bent structure.

The guide bracket 500 can include a bracket body 510 that covers the wire guide 300, and a mounting body 530 extending from the bracket body 510 toward the door. The mounting body 530 is a part fixed to the casing. In some examples, the mounting body 530 can be fixed to the side plate 80. Reference numeral 512 denotes a fastener hole for fixing the bracket body 510 to the wire guide 300.

The mounting body 530 can protrude further from the side of the casing than the bracket body 510. In this way, the mounting body 530 protrudes from the side of the casing and can serve as a kind of spacer to fill the gap between the inner surface of the furniture 1 and the side cover 12.

The mounting body 530 can have an approximately U-shaped cross section. The mounting body 530 can include: a first body 531 connected to the bracket body 510 in a vertical direction; a second body 533 perpendicular to the first body 531 and parallel to the bracket body 510; and a third body 535 perpendicular to the second body 533 and parallel to the first body 531. The first body 531, second body 533, and third body 535 can form a “ [symbol] ” shape, and have a predetermined thickness H. The mounting body 530 can protrude from the side cover 12 by this thickness H. Reference numeral 536 denotes a space formed inside the mounting body 530 bent in the “ [symbol] ” shape.

If the doors 50, 70 protrude further in the left and right width directions (Y-axis direction in FIG. 1) than the side covers 12, the doors 50, 70 occupy the entire front of the furniture 1, and can cover a gap between the furniture 1 and the side cover 12 to enhance aesthetics. However, in this case, the side cover 12 and the inner surface of the furniture 1 are spaced apart, and when the main body 10 can be misaligned inside the furniture 1. In some implementations, the mounting body 530 has a predetermined thickness H, so it can fill the gap between the side cover 12 and the inner surface of the furniture 1. Accordingly, the main body 10 can be aligned to face forward inside the furniture 1.

The mounting body 530 can be provided with a plurality of mounting holes 534. A fastener such as a screw that passes through the mounting holes 534 can assemble the mounting body 530 to the side plate 80. Reference numeral 537 denotes an avoidance part to avoid interference with the doors 50 and 70 during the rotation process of the doors 50 and 70.

The guide bracket 500 can simultaneously cover the lower part of the first wire guide 300A and the upper part of the second wire guide 300B. Through this, the guide bracket 500 can protect both the first wire guide 300A and the second wire guide 300B.

Alternatively, a home appliance can be a single-stage cooking appliance. The single-stage cooking appliance can have a relatively low height compared to the home appliances described above. The wire guide 1300 can be composed of one piece. The lower end of the wire guide 1300 can extend to the lower part of the casing adjacent to the lower frame 20, and the other end of the wire guide 1300 can extend to the equipment room Reference numeral 17 denotes a knob provided separately from the display part 16.

A wire guide 2300 constituting an example of the home appliance will be described. The wire guide 2300 can include a guide base 2310 and a guide cover 2320. The guide base 2310 and the guide cover 2320 can be combined to form the single wire guide 2300.

The wire guide 2300 can be provided with a first guide part 2330 and second guide parts 2340A and 2340B. The first guide part 2330 can be provided with a guide arm 2316 connected to the equipment room S1 and a guide hole OH open inside the guide arm 2316. The first guide part 2330 can be provided at one end of the wire guide 2300.

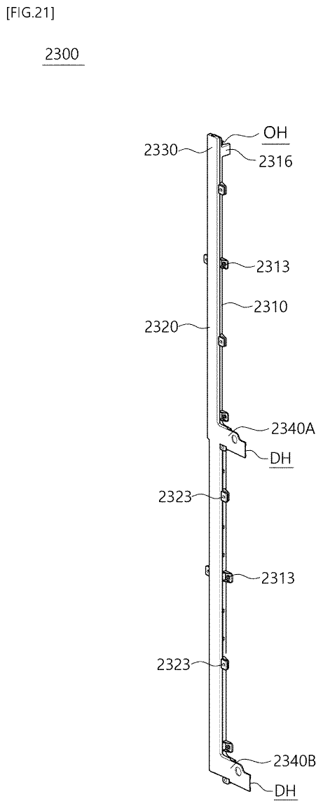

In some examples, the wire guide 2300 can be provided with a plurality of second guide parts 2340A and 2340B. The second guide parts 2340A and 2340B can extend from the wire guide 2300 toward the plurality of doors 50 and 70, respectively. As shown in FIG. 21, the second guide parts 2340A and 2340B can have different heights and protrude in the same direction. The connection wire W1 extending along the second guide parts 2340A and 2340B can be connected to the second electronic components 100 of the upper door 50 and lower door 70, respectively.

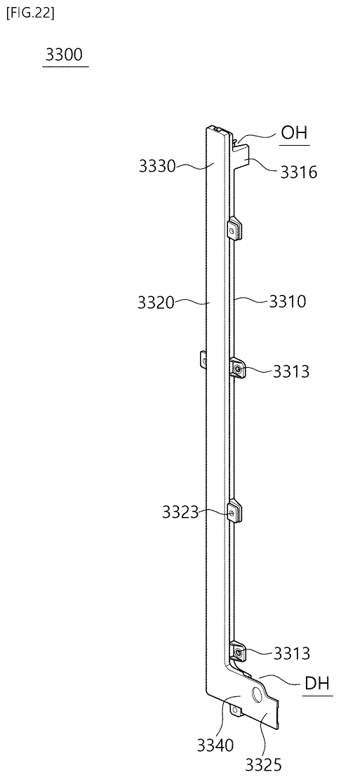

FIG. 22 illustrates a wire guide 3300 constituting an example of the home appliance. As shown, the wire guide 3300 can be configured to have a relatively low height, unlike the previous examples. The wire guide 3300 is disposed on the side cover 12 and can accommodate a part of the wire harnesses W1, W2a, and W2b. The wire guide 3300 can be adjacent to the upper door 50 or adjacent to the lower door 70.

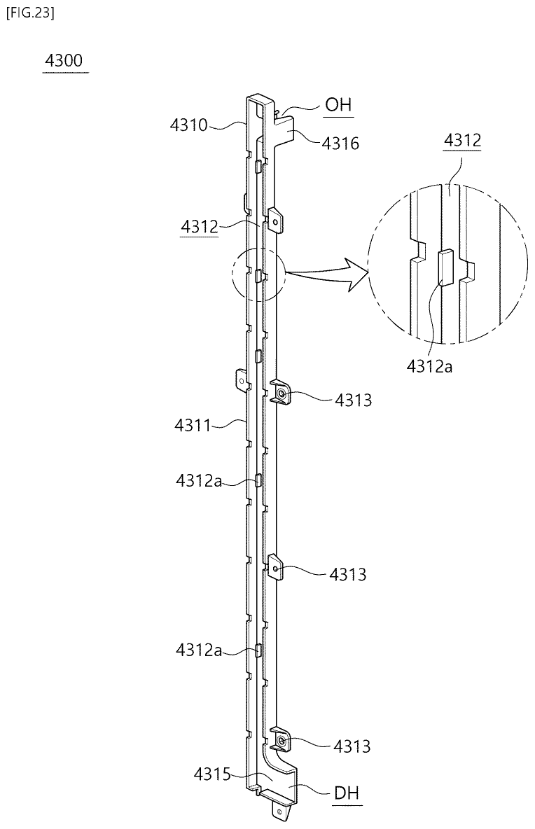

FIG. 23 illustrates a wire guide 4300 constituting an example of the home appliance. As shown, the wire guide 4300 can be composed of only a guide base 4310 without a separate guide cover.

Looking at the enlarged view of FIG. 23, a guide channel 4312 can be formed inside the guide base 4310. A partition rib 4312a can protrude from a bottom part constituting the guide channel 4312. The partition rib 4312a can be disposed between a pair of fence parts 4311. The partition rib 4312a can be erected at the bottom part to partition the guide channel 4312. The partition ribs 4312a can support the surfaces of the wire harnesses W1, W2a, and W2b to prevent the wire harnesses W1, W2a, and W2b from moving inside the guide channel 4312. As another example, the partition rib 4312a can also be provided on the guide base of the previous examples.

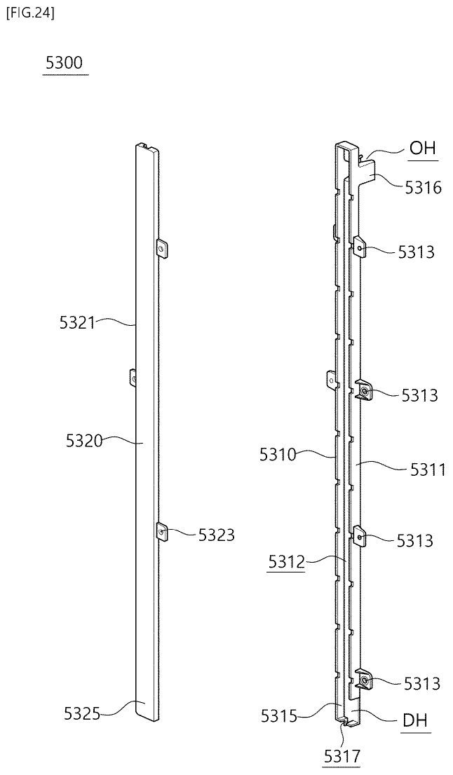

FIG. 24 illustrates a wire guide 5300 constituting an example of the home appliance. As shown, the wire guide 5300 can only extend in one direction. Based on the drawing, the wire guide 5300 extends in the vertical direction.

In some examples, a guide hole OH and a door connection hole DH can be open at both ends of the guide channel 5312 provided in the wire guide 5300, respectively. The guide hole OH and the door connection hole DH can be open in different directions. In this case, the door connection hole DH can be made by omitting a part of the fence part 5311 constituting the wire guide 5300. That is, in some examples, the wire guide 5300 does not have a second guide part extending toward the doors 50 and 70, and the door connection hole DH is provided directly at one end of the wire guide 5300.

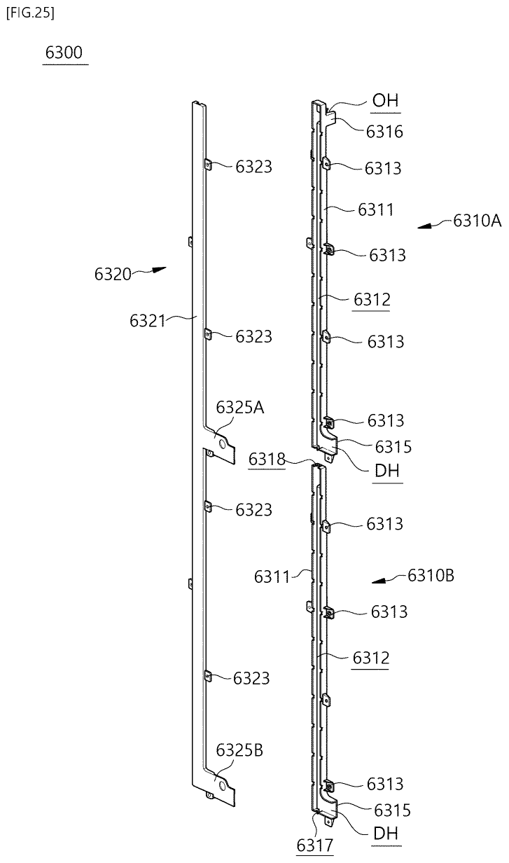

In FIG. 25, a wire guide 6300 constituting an example of the home appliance is illustrated. In some examples, the wire guide 6300 can include two guide bases 6310A and 6310B and a single guide cover 6320. The guide cover 6320 can be coupled simultaneously with the two guide bases 6310A and 6310B. That is, the one guide cover 6320 can shield both guide channels 6312 provided on the two guide bases 6310A and 6310B, respectively.

The guide cover 6320 can be provided with two cover extension parts 6325A and 6325B. The two cover extension parts 6325A and 6325B can be provided at different heights from each other. The two cover extension parts 6325A and 6325B can overlap a base extension part 6315 provided in the first guide base 6310A and the base extension part 6315 provided in the second guide base 6310B, respectively. The two cover extension parts 6325A and 6325B can cover and shield extension channels 6317 provided in each of the two base extension parts 6315.

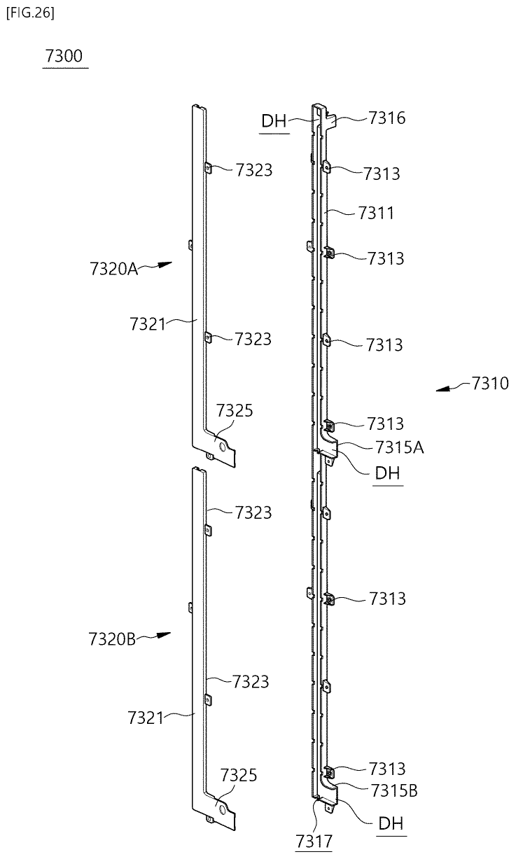

In FIG. 26, a wire guide 7300 constituting an example of the home appliance is illustrated. In some examples, the wire guide 7300 can include one guide base 7310 and two guide covers 7320A and 7320B. Each of the guide covers 7320A and 7320B can be coupled to the one guide base 7310. That is, the two guide covers 7320A and 7320B can shield all of a plurality of guide channels 7312 provided in the one guide base 7310.

The one guide base 7310 can be provided with two base extension parts 7315A and 7315B. The two base extension portions 7315A and 7315B can be provided at different heights from each other. The two base extension parts 7315A and 7315B can overlap cover extension parts 7325 provided on the two guide covers 7320A and 7320B, respectively. The two cover extension parts 7325 can cover and shield extension channels 7317A and 7317B provided in each of the two base extension parts 7315A and 7315B.

The above description is merely an exemplary description of the technical idea of the present disclosure, and any person of ordinary skill in the art to which the present disclosure pertains will be able to make various modifications and modifications without departing from the essential characteristics of the present disclosure. Accordingly, the implementations disclosed in the present disclosure are not intended to limit the technical idea of the present disclosure but to illustrate the technical idea of the present disclosure, and the scope of the technical idea of the present disclosure is not limited by these implementations. The scope of protection of the present disclosure should be interpreted by the following claims, and all technical ideas within the equivalent scope should be construed as being included in the scope of the present disclosure.

What is claimed is:

1. An appliance comprising:
a casing having a storage space therein;
a door disposed at a front of the storage space and configured to open and close at least a portion of the storage space;
a first electronic component disposed outside the casing;
a second electronic component disposed at the door;
a wire configured to electrically connect the first electronic component and the second electronic component; and
a wire guide disposed at the casing and having a guide channel that is configured to store the wire.

2. The appliance of claim 1, wherein the wire guide is disposed at a side surface of the casing in a height direction of the casing.

3. The appliance of claim 1, wherein the wire guide is disposed closer to the door than a center of a side surface of the casing.

4. The appliance of claim 1, further comprising:
an equipment room defined at an upper portion of the casing and configured to receive the first electronic component,
wherein the wire guide is disposed between a first point at an entrance of an interior of the equipment room and a second point at an entrance to the door.

5. The appliance of claim 1, further comprising:
an equipment room defined at an upper portion of the casing and configured to receive the first electronic component,
wherein a first end of the guide channel is open toward the equipment room and a second end of the guide channel is open toward a lower portion of the door.

6. The appliance of claim 5, wherein the upper portion of the casing defines the equipment room and a through-hole,
wherein the wire guide defines a guide hole at one end of the wire guide, the guide hole being connected to the through-hole,
wherein the wire guide comprises a guide arm that is configured to be inserted into the through-hole, and
wherein the guide arm protrudes from the one end of the wire guide and protrudes from an edge of the guide hole.

7. The appliance of claim 1, wherein the wire guide comprises:
a guide base disposed at a side surface of the casing, and
a guide cover that is coupled to the guide base, and
wherein the guide base and the guide cover define the guide channel.

8. The appliance of claim 7, wherein the guide base comprises:
a bottom part configured to accommodate the wire, and
a pair of fence parts disposed at a first side and a second side of the bottom part,
wherein the guide channel is defined between the bottom part and the pair of fence parts,
wherein the wire guide comprises a partition rib that protrudes from the bottom part, and
wherein the partition rib is disposed between the pair of fence parts to thereby partition the guide channel.

9. The appliance of claim 1, further comprising:
an equipment room defined at an upper portion of the casing and configured to receive the first electronic component,
wherein the wire guide comprises:
a first guide part extending toward the equipment room, and
a second guide part that is disposed at one side of the first guide part and extends toward the door.

10. The appliance of claim 9, wherein the first guide part and the second guide part extend in different directions from each other.

11. The appliance of claim 9, wherein the first guide part defines a guide hole that is opened toward the equipment room, and
wherein the second guide part defines a door connection hole that is opened toward a lower portion of the door.

12. The appliance of claim 1, wherein the wire guide comprises:
a first wire guide, and
a second wire guide that is positioned at a different height from the first wire guide, and
wherein the first wire guide and the second wire guide define a continuous guide path.

13. The appliance of claim 12, wherein the first wire guide defines a first channel hole at a lower end of the first wire guide,
wherein the second wire guide defines a second channel hole at an upper end of the second wire guide,
wherein the upper end of the second wire guide faces the lower end of the first wire guide, and
wherein the first channel hole and the second channel hole are connected with each other.

14. The appliance of claim 12, further comprising:
an equipment room defined at an upper portion of the casing and configured to receive the first electronic component,
wherein the first wire guide defines (i) a guide hole that is open toward the equipment room, (ii) a door connection hole that is open toward a lower portion of the door, and (iii) a first channel hole, and
wherein the guide hole, the door connection hole, and the first channel hole are open in different directions from one another.

15. The appliance of claim 1, further comprising:
a side plate that is disposed at a side surface of the casing and disposed closer to the door than the wire guide,
wherein the side plate protrudes further from the side surface of the casing than from the wire guide or forms a continuous plane with the wire guide.

16. The appliance of claim 15, wherein the side plate comprises a plate recess part that is recessed toward the side surface of the casing, and
wherein the plate recess part and the wire guide define a continuous wire path.

17. The appliance of claim 1, wherein the casing comprises a guide bracket, and
wherein the guide bracket is configured to cover one end of the wire guide that is open toward the door.

18. The appliance of claim 17, wherein the guide bracket comprises:
a bracket body configured to cover the wire guide, and
a mounting body that extends from the bracket body toward the door and is fixed to the casing, and
wherein the mounting body protrudes further from a side surface of the casing than from the bracket body.

19. The appliance of claim 12, wherein the casing comprises a guide bracket, and
wherein the guide bracket is configured to cover an area where the first wire guide and the second wire guide are connected.

20. An appliance comprising:
a casing having a storage space therein;
an equipment room defined at an upper portion of the casing;
a door disposed at a front of the storage space and configured to open and close at least a portion of the storage space;
a wire configured to electrically connect the equipment room to the door; and
a wire guide that is disposed at a side surface of the casing in a height direction of the casing and that is configured to store the wire.
